(19) United States
(12) Patent Application Publication
(10) Pub. No.: US 2006/0028576 A1
(43) Pub. Date: Feb. 9, 2006

(54) Imaging apparatus

(75) Inventor: Daisuke Ito, Saitama (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/152,342

(22) Filed: Jun. 15, 2005

(30) Foreign Application Priority Data
Aug. 7, 2004 (JP) 2004-202095

(51) Int. Cl. H04N 5/232

(52) U.S. Cl. 348/345

(57) ABSTRACT

In a digital camera, in-focus position data representative of a distance from a taking lens to a focused subject is obtained from a detection result of an auto-focus detection circuit. Also angle-of-view data representative of an image capturing field is obtained from record of operation on a zooming button. Based on the in-focus position data and the angle-of-view data, a face size determination circuit determines the size of a face that may be contained in a captured image. A face detection circuit detects a face using a frame whose size is defined by the determined face size. A detection result of the face detection circuit is displayed with the target image on an LCD panel. If required, a data base is revised to reflect the detection result.

### FIELD OF THE INVENTION

The present invention relates to an imaging apparatus that captures an optical image of a subject with an imaging device, converts the optical image into digital image data, and stores the image data in a storage medium.

### BACKGROUND ARTS

As an exemplar of imaging device, digital cameras are widely used, which capture optical images of subjects with a solid state imaging device like a CCD image sensor, convert the optical images into digital image data, and store the image data in storage media such as an internal memory and a memory card. There are such digital cameras that detect a face from a captured image, and processes image data of the detected face so as to correct its color or other features. One of those kinds of digital cameras is disclosed in Japanese Laid-open Patent Application No. 2001-309225.

In this prior art, the presence of a face is determined from image data by comparing facial models for searching more than one face candidate regions with facial probabilities to previously screen the image data with a first algorithm, and by performing operation on the face candidate region with a second algorithm by pattern matching so as to check each face candidate region and to confirm the presence of a face in the region.

According to the method disclosed in this prior art, however, it takes many complicated operation processes to detect the presence of a face in the captured image. That means it takes a certain processing time. Moreover, because being gone through a lot of processing steps, an error in the foregoing step could affect the accuracy of detection in the following steps.

### SUMMARY OF THE INVENTION

In view of the foregoing, a primary object of the present invention is to provide an imaging apparatus that saves time taken for detecting a face, and improves accuracy of the detection.

To achieve the above and other objects in an imaging apparatus that captures an optical image of a subject with an imaging device, converts the optical image into digital image data, and stores the image data in a storage medium, the present invention comprises a device for obtaining in-focus position data that represents a distance to a subject focused by a taking lens; a device for obtaining angle-of-view data that represents an image capturing field; a face size determination device for determining based on the in-focus position data and the angle-of-view data a face size of a human subject that can be contained in a captured image; and a face detection device for detecting a human face within a frame whose size is defined by the face size.

According to a preferred embodiment, the imaging apparatus further comprises a storage device for storing a data base to be referred to on detecting the face; an image display device for displaying a detection result of the face detection device together with the captured image; and a selection device for selecting whether to record the captured image in the storage medium or not, wherein the storage device revises the data base to reflect the detection result when the captured image is selected to be recorded on the storage medium.

Since the face is detected by scanning or screening the image with a frame whose size is defined by the face size that is determined based on the in-focus position and the angle-of-view of the image, the processing time necessary for the face detection is remarkably saved in comparison with the prior art where each image is scanned many times using different size frames.

Furthermore, the data base to be referred to on the face detection is revised according to the decision of the user, the data base will be more useful for the face detection, so the accuracy of face detection is improved.

### BRIEF DESCRIPTION OF THE DRAWINGS

The above and other objects and advantages will be more apparent from the following detailed description of the preferred embodiments when read in connection with the accompanied drawings, wherein like reference numerals designate like or corresponding parts throughout the several views, and wherein:

FIG. 1 is a perspective view of a digital camera embodying the present invention;

FIG. 2 is a rear view of the digital camera;

FIG. 3 is a block diagram illustrating the circuitry of the digital camera;

FIG. 4 is an explanatory diagram illustrating a data table;

FIG. 5 is an explanatory diagram illustrating a preview screen displayed on a display panel of the digital camera; and

FIG. 6 is a flowchart illustrating a processing sequence of the digital camera in a face correction mode.

### DESCRIPTION OF THE PREFERRED EMBODIMENTS

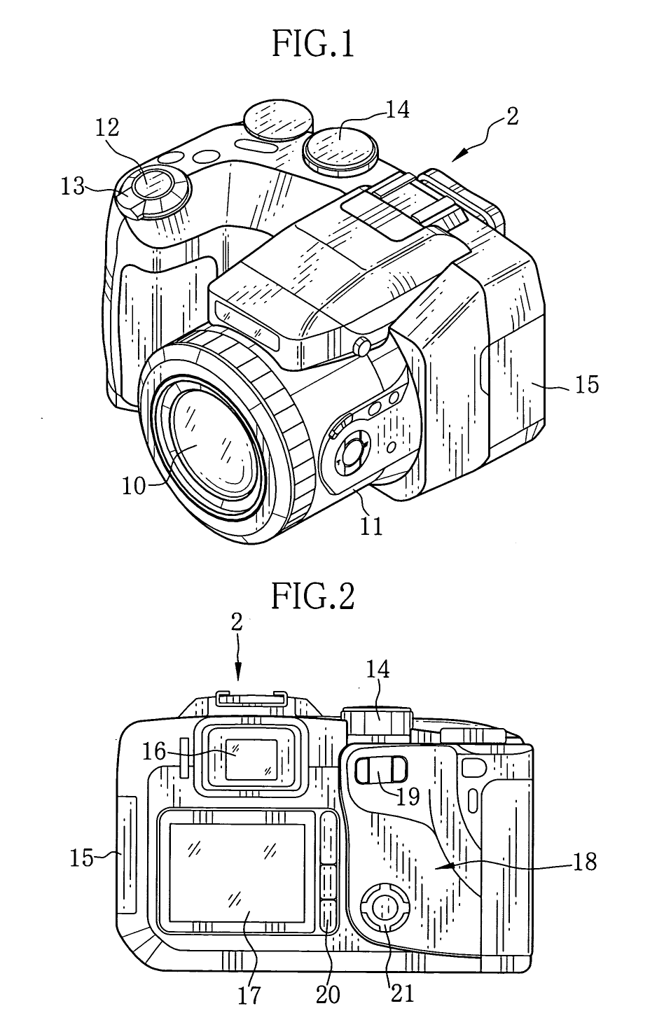

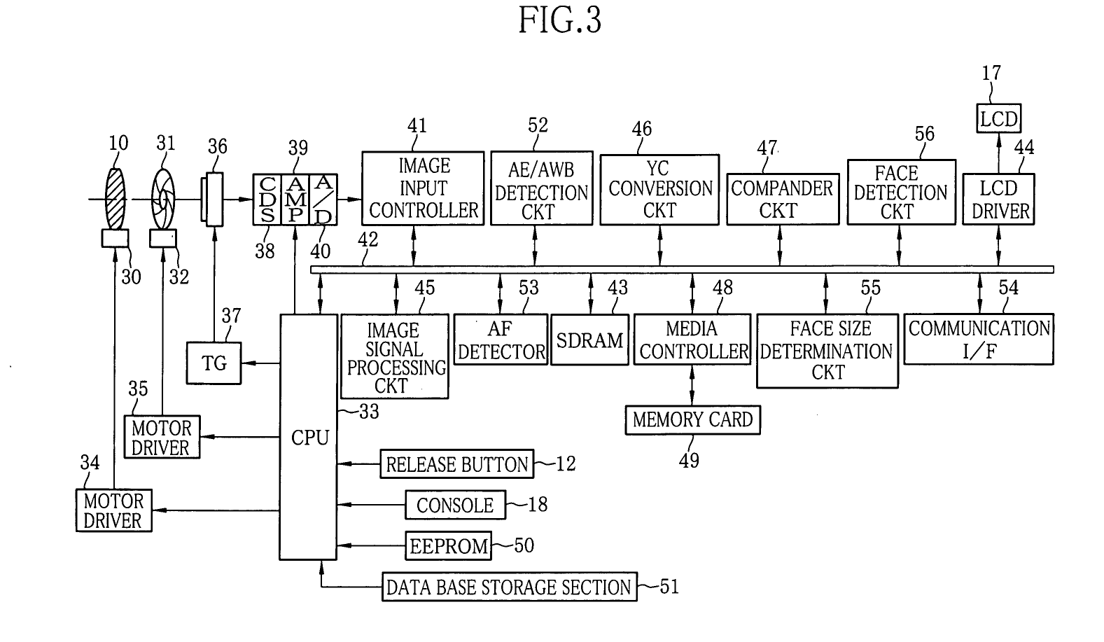

A digital camera 2 shown in FIGS. 1 and 2 has on its front a lens barrel 11 holding a taking lens 11, and on its top a shutter release button 12, a power switch 13 and a mode dial 14. A lid 15 provided on one side of the digital camera 2 covers a not-shown memory card slot in which a memory card 49, see FIG. 3, can removably be inserted.

On a rear side of the digital camera 2 are provided a finder eyepiece window 16, a liquid crystal display (LCD) panel 17 and a console 18. The LCD panel 17 displays captured images and so-called camera-through images, and a various kinds of menu screens. The console 18 is constituted of a zooming button 19 for changing room rate of the taking lens 10 toward a wide range or a telephoto range, a menu button 20 that is operated for making the LCD panel 17 display a menu screen, and an arrow key 21 for moving a cursor on the menu screen.

The digital camera 2 can work in a still image capture mode, a movie image capture mode, a reproduction mode for displaying captured images on the LCD panel 17, and a setup mode for setting up the digital camera 2 with respect to many items. Switching between these modes is performed by turning the mode dial 14. In the movie image capture mode, atmospheric sounds are recorded through a not-shown microphone while movies are being captured.

The digital camera 2 is also provided with a face detecting mode for detecting a face of a human subject from a captured image and for processing image data of the detected face to correct its color and to apply many other kinds of image-processing. The face detecting mode is selected by operating the console 18, and the contents of the processing to apply on the face are also set up by operating the console 18.

The release button 12 constitutes a two-step switch. When the release button 12 is pressed lightly or halfway, the digital camera 2 executes preparatory processing for the image capture, including automatic exposure control (AE) and automatic focusing (AF), with respect to a subject framed through the optical viewfinder or the LCD panel 17 that serves as an electronic viewfinder when displaying the camera-through images. When the release button 12 is pressed fully, a frame of image signal is captured under the prepared conditions, and is converted into digital image data. The image data is processed and compressed in a way as set forth below, and is written on the memory card 49.

Referring to FIG. 3 showing the circuitry of the digital camera 2, the taking lens 10 is connected to a lens motor 30, whereas a diaphragm 31 is connected to an iris motor 32. These motors 30 and 32 are stepping motors, and are driven by drive pulses sent applied from motor drivers 34 and 35 under the control of a CPU 33 in the preparatory processing.

The lens motor 30 causes a not-shown zoom lens of the taking lens 10 to move between a wide terminal and a telephoto terminal in cooperation with the zooming button 19. The lens motor 30 also causes a not-shown focusing lens of the taking lens 10 to move in accordance with a detected subject distance and a zooming magnification, to adjust focus for optimum imaging conditions. The iris motor 32 causes the diaphragm 31 to move so as to adjust the exposure.

A CCD 36 located behind the taking lens 10 captures an optical image of a subject that is formed through the taking lens 10. The CCD 36 is connected to a timing generator (TG) 37. Shutter speed of an electronic shutter of the CCD 36 is decided by a timing signal or clock pulses supplied from the timing generator 37, and the timing generator 37 is controlled by the CPU 33.

The image signal output from the CCD 36 is sent to a correlated double sampling circuit (CDS) 38, which outputs image data of three primary colors (R, G, B) that exactly reflect volumes of electric charges accumulated in respective cells of the CCD 36. The image data output from the CDS 38 is amplified at an amplifier (AMP) 39 and is converted into a digital form through an A/D converter 40.

An image input controller 41 is connected to the CPU 33 through a data bus 432, so that the image input controller 41 controls the CCD 36, the CDS 38, the amplifier 39 and the A/D converter 40 in accordance with commands from the CPU 33. The image data from the A/D converter 40 is stored temporarily in a SDRAM 43, and is displayed on the LCD panel 17 through a LCD driver 44.

An image signal processing circuit 45 reads the image data out of the SDRAM 43, and processes it for gradation conversion, white-balance correction, gamma correction and the like. The processed image data is stored in the SDRAM 43 again. An YC conversion circuit 46 reads the processed image data from the SDRAM 43, and converts it into an illuminance signal Y and color difference signals Cr and Cb. A compander circuit 47 compresses the converted image data according to a predetermined compression format, e.g. JPEG format. The compressed image data is written on the memory card 49 by way of a media controller 48.

The CPU 33 is also connected to the release button 12, the console 18, an EEPROM 50 and a data base storage section 51. The EEPROM 50 stores various control programs and setup data. The CPU 33 reads some of these programs and setup data from the EEPROM 50, and writes them on the SDRAM 43 that serves as a work memory, thereby to perform necessary processing.

The data base storage section 51 stores a data base which is referred to by a face detection circuit 56 on detecting a face of a human subject, as set forth in detail below. The data base contains customized data that represents information specific to the user of the digital camera 2, such as the manner or tendency of composition or the facial skin color. The data base also contains detection parameters previously used in the face detection circuit 56.

To the data bus 42, an AE/AWB circuit 52, an AF detection circuit 53, a communication interface 54, a face size determination circuit 55 and the face detection circuit 56 are also connected. The AE/AWB circuit 52 detects as to whether a decided exposure amount, i.e. the electronic shutter speed, and an aperture size of the diaphragm 31 are proper or not, and also whether the white-balance is proper or not. The AF detection circuit 53 detects as to whether the focus of the taking lens 10 is proper or not. The communication interface 54 is for communicating data with external apparatuses. Although it is not shown in the drawings, a flash control circuit for controlling a flash device of the digital camera 2 is also connected to the data base.

The AE/AWB detection circuit 52 and the AF detection circuit 53 send detection results to the CPU 33 via the data bus 42 each time the release button 12 is pressed halfway. The CPU 33 controls the taking lens 10, the diaphragm 31 and the CCD 36 on the basis of the detection results from these detection circuits 52 and 53.

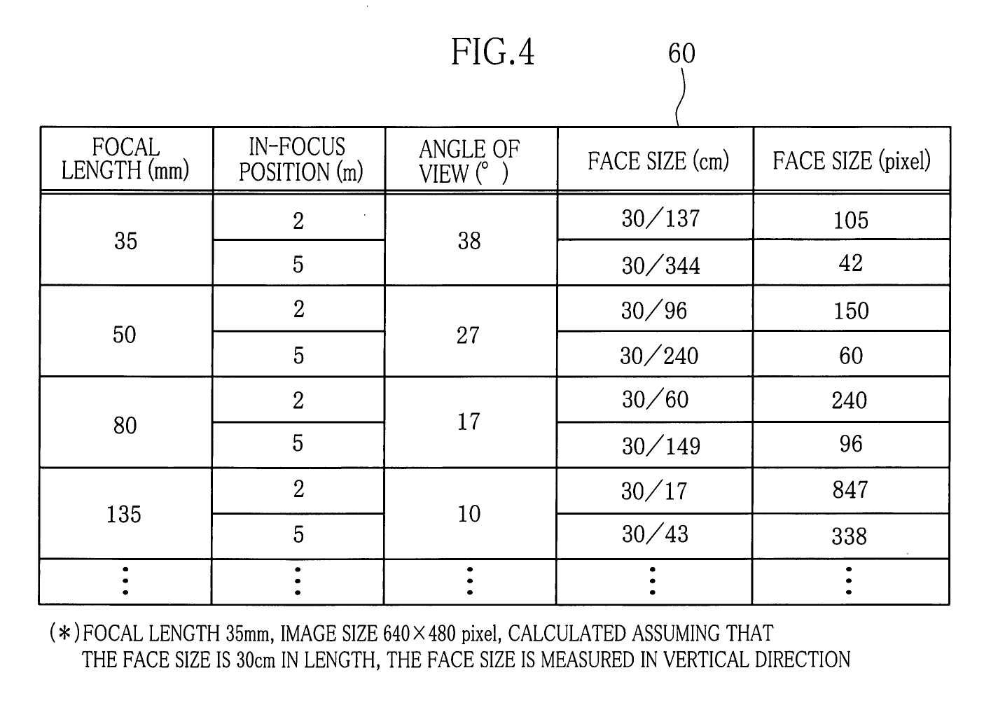

The CPU 33 also gets in-focus position data from the detection results sent from the AF detection circuit 53. The in-focus position data represents a distance from the taking lens 10 and a focused subject. The CPU 33 further gets angle-of-view data from records of operation done on the zooming button 19. The angle-of view data represents an image capturing field. The CPU 33 sends the in-focus position data and the angle-of-view data to the face size determination circuit 55. Based on the in-focus position data and the angle-of-view data, the face size determination circuit 55 determines the size of a face of a human subject that can be contained in the captured image, while referring to a data table 60 that is previously stored in the EEPROM 50. As shown in FIG. 4, the data table 60 shows relationship between the in-focus position and the angle-of-view, on one hand, and the face size, on the other hand. Numerical values shown in the data table are calculated assuming that the taking lens 10 has a focal length of 35 mm in an initial position, the angle of view is measured in the vertical direction, the image sizes is 640×480 pixels, and the actual face size of the human subject is 30 cm in the vertical direction.

The face detection circuit 56 detects a face from the image within a frame that is defined by the face size determined by the face size determination circuit 55. For example, if the determined face size is 105 pixels, the face detection circuit 56 scans or screens the image with a frame of 105×105 pixels, to detect a face within the frame.

The face detection circuit 56 further determines the order of priority among image portions on scanning or screening the image and the skin color to extract, i.e. the color of pixels to extract as constituting a face, while referring to the data base stored in the data base storage section 51. For example, if the data base includes such customized data that shows that the user tends to locate a human subject on the lower right portion of the image, the face detection circuit 56 first scans the lower right portion of the image, and then scans all portions of the image sequentially. To detect the presence of a human face, the face detection circuit 56 extracts pixels representative of skin color from the image portion bounded by the frame, and calculates the proportion of the skin color pixels to all pixels of the frame. If the calculated proportion is above a predetermined value, the face detection circuit 56 judges that there is a face in the frame.

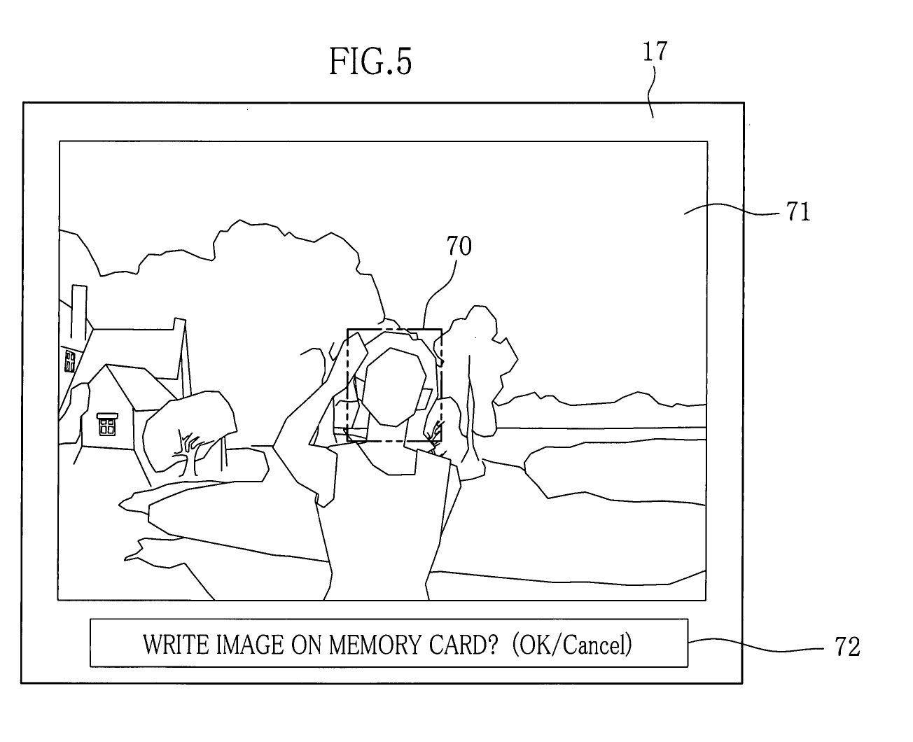

When the face detection circuit 56 detects the presence of a face, the detection result is displayed as a preview screen on the LCD panel 17, as shown in FIG. 5, wherein the detection result is indicated by phantom lines 70 on the target image 71. On the preview screen, a dialogue 72 is also displayed under the image 71, to ask whether to record the image 71 on the memory card 49 or not.

If “OK” is selected in the dialogue 72, the image 71 is written on the memory card 49. Simultaneously, the data base storage section 51 revises the data base to reflect the detection result of the face detection circuit 56. That is, detection parameters previously recorded in the data base, which representative of detected face regions and facial color, are corrected with the new detection parameters. On the other hand, if “cancel” is selected in the dialogue 72, the image 71 is cleared without being written on the memory card 49. In that case, the data base is not revised.

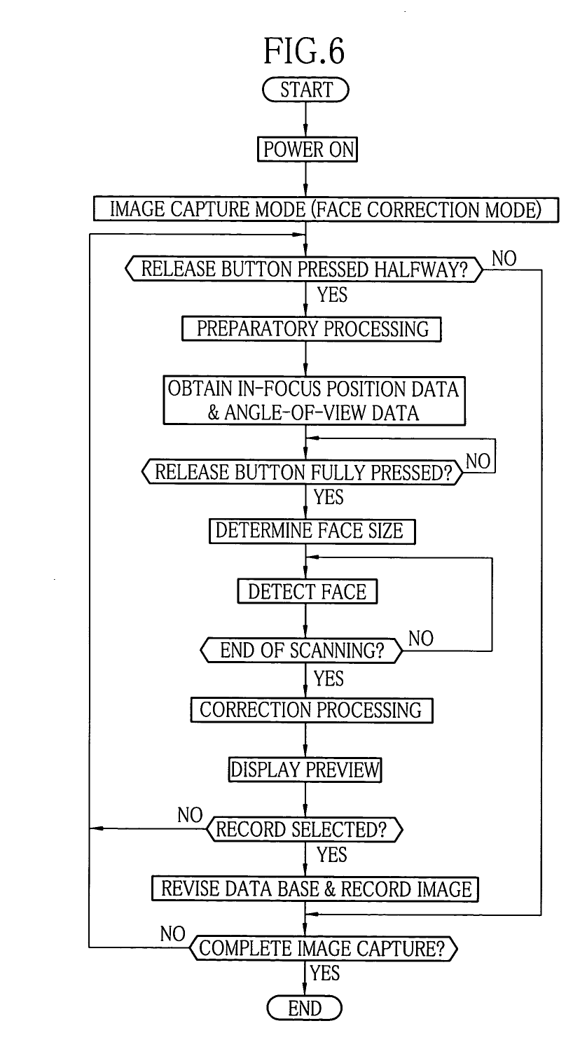

Now the operation of the digital camera 2 will be described with reference to the flowchart of FIG. 6. To capture an image, the digital camera 2 is powered by turning the power switch 13 on, and the still image capture mode or the movie image capture mode is selected by operating the mode dial 14.

In either image capture mode, an optical image of a subject is formed through the taking lens 10 and falls through the diaphragm 31 on the CCD 36, so the CCD 36 converts the optical image into electric values, and the electric values are sampled by the CDS 38, to be output as image data. The image data is amplified by the amplifier 39, and is converted into digital image data through the A/D converter 40.

The digital image data is processed in the image signal processing circuit 45, and sequentially written in the SDRAM 43 through the image input controller 41, so camera-through images are displayed on the LCD panel 17. When the release button 12 is pressed halfway, AE/AWB detection circuit 52 and the AF detection circuit 53 detects optimum exposure value, white-balance and focus. Based on these detection results, the preparatory processing is executed.

When the release button 12 is fully pressed after the preparatory processing, an image capture is executed. Specifically, in the still image capture mode, a frame of image data that is stored in the SDRAM 43 at that moment is transferred to the YC conversion circuit 46, and is converted into an illuminance signal Y and color difference signals Cr and Cb. Thereafter, the image data is compressed by the compander circuit 47, and written on the memory card 49 through the media controller 48.

On the other hand, if the release button 12 is fully pressed in the movie image capture mode, a number of frames of image data are picked up at a constant frame rate, e.g. 30 frames per second, and are written on the memory card 49, till the release button 12 is fully pressed again. Simultaneously, atmospheric sounds are collected through the microphone. The collected sounds are recorded on the memory card 49 in association with the image data.

If the face correction mode is selected by operating the console 18, as shown in FIG. 6, the in-focus position data is obtained from the detection results that are sent from the AF detection circuit 53 after the preparatory processing. Also the angle-of-view data is obtained from the operation record of the zooming button 19. The in-focus position data and the angle-of-view data are sent to the face size determination circuit 55 through the CPU 33.

When the image capture is executed in response to the full pressing of the release button 12, the face size determination circuit 55 refers to the data table 60 as stored in the EEPROM 50, to determine based on the in-focus position data and the angle-of-view data the size of a face of a human subject that may be included in the captured image. After the face size is determined, the face detection circuit 56 starts detecting a face by scanning the image with a frame defined by the determined face size.

The face detection circuit 56 refers to the data base stored in the data base storage section 51, to decide the order of priority on scanning the image portions with the frame, and the skin color of the face to detect. Then, those pixels which represent the decided skin color are extracted from the image portion bounded by the frame, and the proportion of the extracted pixels to all pixels in the frame is calculated. Next, the calculated proportion is compared with a predetermined value. If the proportion is more than the predetermined value, the face detection circuit 56 judges that there is a face within the frame. The same face detection process is carried out while scanning the whole area of the image.

After the face detection, the CPU 33 processes the image data to correct the image according to the correction parameters set by the console 18. After the image correction, a preview screen containing the target image 71 and the detection result 70 of the face detection circuit 56 is displayed on the LCD panel 17, as shown for example in FIG. 5.

If “OK” is selected in the dialogue 72 on the preview screen, the image 71 is written on the memory card 49. Simultaneously, the data base storage section 51 revises the data base to reflect the detection result of the face detection circuit 56. If “cancel” is selected in the dialogue 72, the image 71 is cleared without being written on the memory card 49, and the data base is not revised.

As described so far, the size of a face in an image is determined based on the in-focus position and the angle-of-view of the image, and the face in the image is detected by scanning the image with a frame that is defined by the face size. Therefore, in comparison with the prior art where different sizes of frames are prepared for the face detection, and the image is scanned many times using the different size frames, the processing time necessary for the face detection is remarkably saved. Furthermore, the data base to be referred to on the face detection is revised according to the decision of the user, the data base will be more useful for the face detection, so the accuracy of face detection is improved. Therefore, the digital camera 2 can get comfortable working conditions.

It is alternatively possible to write the in-focus position data and the angle-of-view data in an Exif tag simultaneously with recording the image on the memory card 49. Then, the face may be detected from the image in the same way as above based on the data written in the EXif tag, so as to execute the face correction on an external apparatus like a personal computer, while connecting the digital camera 2 to the external apparatus.

Although the present invention has been described with respect to the preferred embodiment shown in the drawings, the present invention is not to be limited to the above embodiment. On the contrary, various modification will be possible without departing from the scope of claims appended hereto.

What is claimed is:

1. An imaging apparatus that captures an optical image of a subject with an imaging device, to convert the optical image into digital image data, and record the image data in a storage medium, said imaging apparatus comprising:
a device for obtaining in-focus position data that represents a distance to a subject focused by a taking lens;
a device for obtaining angle-of-view data that represents an image capturing field;
a face size determination device for determining based on said in-focus position data and said angle-of-view data a face size of a human subject that can be contained in a captured image; and
a face detection device for detecting a human face within a frame whose size is defined by said face size.

2. An imaging apparatus as claimed in claim 1, further comprising:
a storage device for storing a data base to be referred to on detecting the face;
an image display device for displaying a detection result of said face detection device together with said captured image; and
a selection device for selecting whether to record said captured image in said storage medium or not, wherein said storage device revises said data base to reflect said detection result when said captured image is selected to be recorded on said storage medium.

3. An imaging apparatus as claimed in claim 1, wherein said angle-of-view data is obtained from record of operation on a zooming device to change focal length of said taking lens.

4. An imaging apparatus as claimed in claim 1, wherein said face size determination device determines the face size in terms of pixel number.

5. An imaging apparatus as claimed in claim 4, wherein said face detection device extracts pixels representative of a skin color from an image portion bounded by said frame, calculates the proportion of said extracted pixels to all pixels included in said image portion, wherein if the calculated proportion is above a predetermined value, the face detection device judges that there is a face in said frame

6. An imaging apparatus as claimed in claim 2, wherein said data base contains data representative of previously detected face regions and skin colors of said face regions.

7. An imaging apparatus as claimed in claim 6, wherein said face detection device refers to said database, to decide the order of priority among image portions on scanning said captured image with said frame, and a skin color of the face to detect.
